(19) United States
(12) Patent Application Publication
(10) Pub. No.: US 2007/0106931 A1
(43) Pub. Date: May 10, 2007

(54) Active notes application

(75) Inventors: Panu Vartiainen, Lahti (FI); Suresh Chande, Vantaa (FI); Chand Malu, Vantaa (FI); Kimmo Ramo, Espoo (FI); Murali Krishna Punaganti Venkata, Vantaa (FI); Petteri Saarinen, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/270,890

(22) Filed: Nov. 8, 2005

(51) Int. Cl. G06F 17/00

(52) U.S. Cl. 715/512

(57) ABSTRACT

A method, device and computer program for the active notes application together with an application user interface (UI) is described in which the active notes application running on the mobile terminal is invoked in response to a user action or automatic event. Data entry and action event entry into the active notes application is made by a variety of input devices including proximity and location sensor. The entered data is embedded into an association application for example, contact manager, calendar and phone book running on the mobile terminal. The action is executed with the data specified using the corresponding associated application for the type of action identified whereby the notes are made active.

### TECHNICAL FIELD

The present invention relates generally to office and personal productivity applications and deals more particularly with an application that creates active notes from embedded actions and data.

### BACKGROUND OF THE INVENTION

People typically take notes as a convenient way to create a written reminder of key issues, points, events, and reminders and to list “To-Do” items in their work or personal life. Note taking is highly personal and each person has his or her own style of note taking. Thus, although the notes taken are typically meant for local and personal use, the notes taker may share the notes with others. For example, a person may make notes and lists his/her TO-DO's but then decides to send the TO-DO list to another person. In this case, the TO-DO's list is used to allocate tasks to another person. Hence, although personal notes are made they are then shared. Another example of personal notes being shared are meeting minutes with various action items allocated to other people thus the notes are personal but also are made to cover teams, groups of people or other individuals charged with carrying out the action items. Often the note taking is done with the assistance or help of small handbooks, pocket books or by using applications available in electronic devices such as Tablet PCs, PDAs, Smart Phones and other similar devices.

One known prior art note taking application is a simple text based note taking tool that has no additional functionality. The text of the note is manually typed in or the text is copied and pasted into the note for example, from a word processing or another document to create the note text manually using the copy and paste feature of the word processing application.

Other known prior art note taking applications are available, for example, from Microsoft Corporation and 3M Corporation, which allow a user to “stick” a note on a document displayed on a computer screen. The known prior art note taking applications may offer or suggest to the user to embed some application data such as a document and/or link, however the prior art lacks interaction with the note taking applications and note taking application interactions with other applications. Some note taking applications simplify note taking through the use of a stylus or pen in which human handwriting recognition is carried out to transfer what a person doodles or writes on a screen or tablet using natural handwriting-to-text characters that are recognized by the software.

The notes typically denote a set of things related to a particular event or action that needs be carried out and are generally related to a set of actions that has happened or to actions that are to be executed in the near future. The currently known and available note taking applications do not simplify or provide a means on how such actions can be carried out. Further, the known note taking tools or applications do not help in writing the note in any simple manner even though the necessary information for the note may be accessible to the device.

The notes once taken down are not easily accessible to the user based on the actions and events that are occurring. In known note taking applications, notes can be made available by predefined scheduled reminders in an ad hoc manner, for example, in a time or date sequenced order. The notes cannot however be organized and made available in accordance with specific actions and events that occur as recorded in the contents of the taken notes.

It would be desirable therefore to provide a note taking application that overcomes the disadvantages and shortcomings of currently known note taking applications and devices.

It would also be desirable to provide an active note application that allows access to application data which can be used to embed into the notes, enable invocation of local applications, allow access to the notes on the occurrence of specific external events or actions, and enable embedding of the data automatically into the notes in response to actions performed.

### SUMMARY OF THE INVENTION

A method, device and computer program is presented in accordance with the active notes application embodying the invention. A broad aspect of the invention includes invoking the notes application in response to a user action or automatic event, entering data into the notes application, entering an action event into the notes application, embedding the entered data into an associated application such as for example, a contact manager, document handling, calendar, phone book, address book, browser, messaging, an similar applications, and then executing the action with the data specified using the corresponding associated application for the type of action identified whereby the notes are made active.

### BRIEF DESCRIPTION OF THE DRAWINGS

FIG. 1 is a functional block diagram illustrating one embodiment of the active note application architecture of the present invention;

FIG. 2 is a schematic presentation of an application UI adapter which may be utilized with the active notes application embodying the invention;

FIG. 3 shows an example of a note created in the active notes application embodying the invention;

FIG. 4 shows an example of a notes edited with the active notes application embodying the invention;

FIGS. 5-7 are schematic representations of an application UI adapter in a further example of the active notes application embodying the invention;

FIG. 8 is a functional block diagram of a suitably configured terminal with which the active note application of the present invention may be used.

### WRITTEN DESCRIPTION OF PREFERRED EMBODIMENTS

Turning now to the drawings and considering the invention in further detail, the active note application embodying the present invention is referred to herein as “Active Notes” and may be defined as “actions along with data” wherein the application handling the action/data combination makes the notes active.

The active note application of the invention may be utilised in a number of different scenarios such as for example, in meeting organizing such as following-up actions points identified in pre-meetings, producing meeting minutes and actions points allocations during the meetings, and following-up on action points and updating status of the meeting action points in post meetings.

Another scenario in which the invention “Active Notes” is particularly well suited for is in the realm of personal action reminders such as for example, shopping lists, list of things “TO DO” and discussion points.

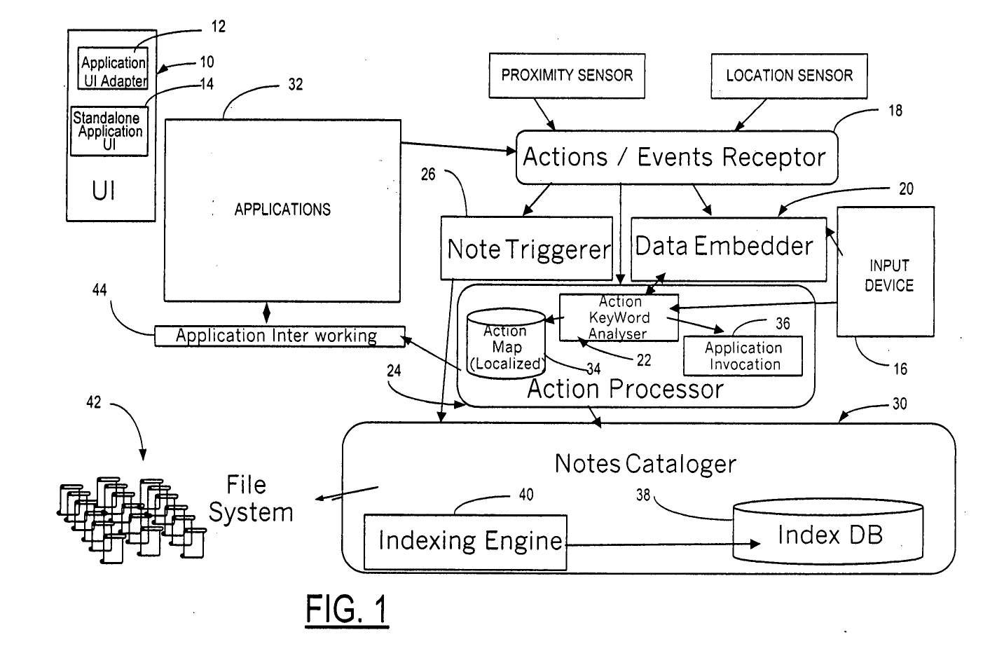

The active note application of the invention is a note taking tool that allows the use of personal data to create notes including for example, agendas, task lists, meeting minutes, etc. with embedded active items and is shown in an exemplary architecture as illustrated in FIG. 1 and is particularly well suited for use in mobile devices. The embedded active items include for example but not limited to embedding application data, invoking applications, embedding notes to applications, activation of notes by events such as calls, reminders and input data from external sources.

The architecture of the active note application embodying the invention can also be implemented as a standalone application and it will be recognized by those skilled in the art that different architectural approaches may also be utilized to carry out the implementation. Accordingly, the architecture shown in FIG. 1 and the corresponding functionality as described herein below form the fundamental functional basis of the active note application concept of the invention.

With continued reference to the “Active Notes” architecture shown in FIG. 1, the major functional blocks are described for purposes of gaining a fuller understanding of the invention.

An input device generally designated 16 provides the necessary capabilities to input data necessary to create an Active Note. The input device 16 may be any suitable device such as, for example, a digital pen, stylus pen, keypad of the terminal or mobile device, OCR, keyboard, speech-to-text, voice notes and other sources suitable to carry out the intended function to input data. The Active Note can also be created as a result of sharing the embedded entered data with one or more other associated or core applications.

An action/event receptor module generally designated 18 functions to receive and process accordingly the received external/internal triggers and events. The external/internal triggers and events will make the relevant notes visible to the user or embed the data or show the active notes in response to the external/internal triggers and events.

Application events and actions are events raised as a result of use of a specific application, for example call received, calendar reminder, visiting a specific web site, document handling and other such events and actions.

A proximity based event or action is an action or event that occurs on identification by the system that it is within the proximity limits of another entity. For example, by scanning Bluetooth devices that may be in range, using RFID readers, 2D barcode scanners, etc.

The action/event receptor 18 may also receive a sensor event input from one or more external sensors attached to the terminal device. For example, a suitably configured medical monitor attached to the user of a terminal device such as for example, a mobile device, can send an alarm indicating that the heart beat rate is too high and hence as a result an active note related to precautions that need to be taken can be triggered and shown to the user on the display screen of the mobile device.

The action/event receptor 18 may also receive location based events or actions which are event or actions that are received stating the user of the mobile device has reached a specific location, for example by GPS, Cell ID, or other suitable means to carryout the intended function. In response to a given location based event or action, reminders specific to that location are made available.

A data embedder module generally designated 20 functions to embed the data into the notes as the data embedder receives the data from the input device 16 or from the action/events receptor 18. The data from the data embedder 20 is also fed into a action keyword analyzer 22 of the action processor module 24 as the data arrives from the action/events receptor 18 or from other applications 32 via the actions/events reception 18. The keyword analyzer 22 is used to identify any relevant keywords and in response thereto proposes possible inclusion of data from the applications within the terminal device into the Active Notes. For example, when a user types “call”, the system on identifying the user's intention for the action call, will propose the user pickup the name from the contacts application. The data embedder module 20 also functions to provide means to invoke the data embedded into the Active Notes. The keywords may be configurable to support specific locality usage or international usage of the active notes application of the invention by providing the keywords in one or more languages to accommodate localization.

The note triggerer module generally designated 26 functions based on actions or events from the action/event receptor 18 to decide if a specific note needs to be triggered and if so, the notes triggerer module 26 consults with a notes cataloger module generally designated 30 to invoke and trigger the Active Notes.

The action processor module 24 processes any action-oriented entry within an active note. The action processor 24 is responsible for the actions related processing during the creation of the active note or usage of the active note. During the creation phase of the active note, the action processor module 24 functions to propose corresponding data that should or could be embedded into the active note, as defined in the data embedder module 20. During the usage, the action processor module 24 functions to invoke the correct associate or applications and further to even embed the data information which arrives at different times. The data information can arrive to the active note as a result of actions or events that occur in the application 32 including but not limited to contacts, calendar, messaging, documents handling, browser, audio and image media or other applications running on the terminal device. For example this data could be information that arrives to the system as a result of an SMS being sent to the terminal device.

The action keyword analyser module 22 functions to analyze the keywords that are typed in by the user. The analysed keywords are mapped to an action map generally designated 34 against a specific associated application and accordingly, the user is opted with choices related to which application data should or could be embedded into the active note. In situations where some actions happen in the system rather than typed in by the user, the module 22 functions to analyze based on the occurrence as to what processing needs to be carried out by performing a look-up on the actions map. For example, some specific data might be required to be embedded into the active note and in such cases the analyzer uses the data embedder 20 to embed this data into the active notes.

The application invocation module generally designated 36 functions to invoke a specific associated or core application with the necessary information available in the active notes. The application invocation module 36 is triggered by the action keyword analyser module 22 in response to an automatic selection or to a selection by a user of a specific action in the active note.

The action map module 34 contains a map of actions corresponding to specific tasks that are to be executed. The task could be for example, invocation of a specific application, or the embedding of a specific extracted data from the core application back into the Active Notes.

The notes cataloger module 30 functions to extract all relevant important data from created and/or shared and/or received active notes, and to catalog the active notes. The relevant data extracted is used for indexing the relevant Active Notes in an index database 38 via a suitable indexing engine 40 so that when specific events or actions occur, the indexed information 38 is utilized to trigger the right Active Notes. The step of triggering a specific active note can be for the purpose of displaying the notes or to update the specific event with relevant data. The Notes cataloger 30 could utilize a local File system 42 or a database 38 to store the Active Notes in the System.

The indexing engine module 40 contains the indexing information about the Active Notes. The indexing engine module 40 provides suitable features to index, search and find Active Notes.

The index DB module 38 is a database of the index information and it can also, if necessary, contain the Active Notes.

The local file system 42 is utilized as one of the possible solutions to store the Active Notes.

The application inter-working module 44 functions to facilitate embedding the applications 32 with Active Notes and to embed Active Notes with the associated or core applications. The applications 32 are the set of applications available on the terminal device with which the active notes application is used.

The user interface (UI) module generally designated 10 is responsible for the UI generation for the Active Notes. The UI module 10 includes an associated application UI adapter generally designated 12 which functions to represent the active note when the note-taking tool is part of a core or associated application or is embedded within a core or associated application.

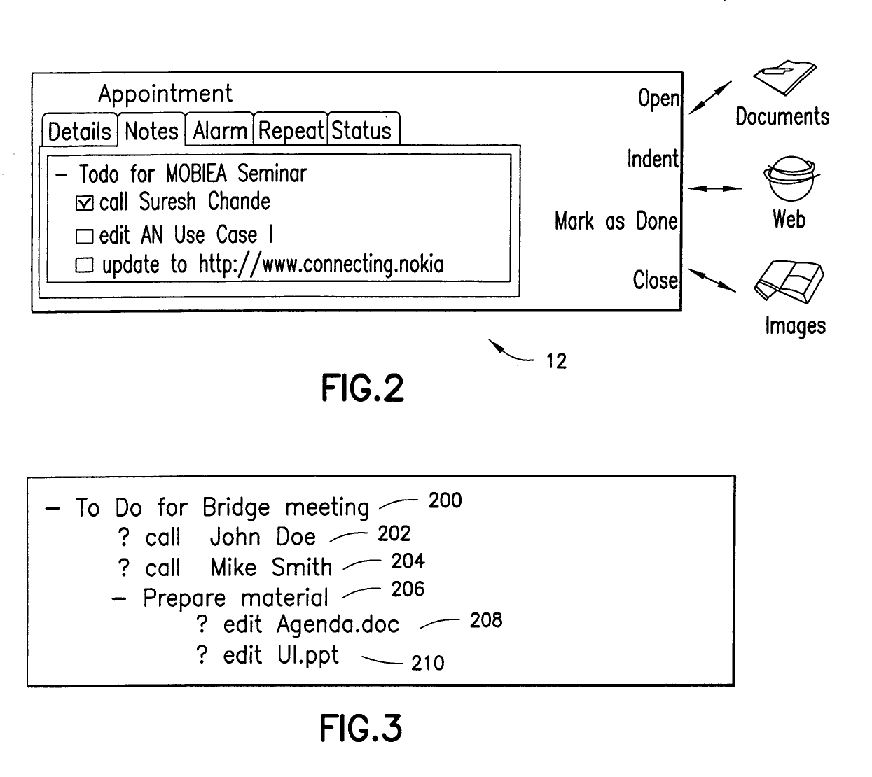

An associated application UI adapter 12 is illustrated for example in FIG. 2 as it might appear on the screen of a terminal device such as a mobile phone. In FIG. 2, the UI adapter 12 shows a notes tab for a general heading “Appointment”. The Notes tab may have been automatically revealed when the user opened the calendar application and selected or highlighted appointment. Now in accordance with the invention, active items are listed for the To Do task for a seminar. The To Do line is a calendar Event which comes from the subject of the calendar event. Each line of text is a note and any line can be converted to a To Do. Every line that follows a higher line can be indexed into a deeper hierarchy and the note can be marked as done or undone. In FIG. 2, the person's name Suresh Chande is an embedded contact for example from the contacts or associated application. The AN Use Case is an embedded document for example from a document handling or word processing or associated application. The URL address is an embedded address for example from a web browser or associated application.

The active notes application of the invention also contemplates a full application UI. A Standalone Application UI module 14 provides the complete UI for the Active Notes and has the capability to include images, audio, phone call recording and other functions commonly known wherein each of the actions generates its own UI in the Standalone Application UI. When invoked from the UI 10, the standalone application UI 14 can be triggered on selection.

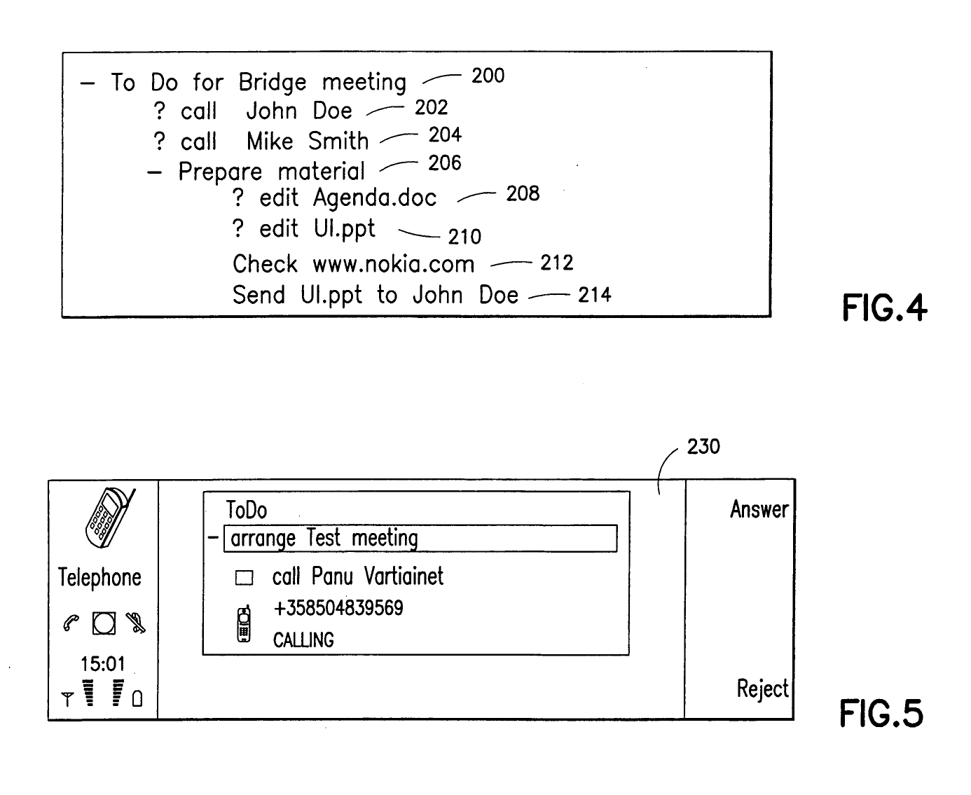

Turning now to FIG. 3, a new note can be created for example considering the scenario of preparing for a meeting utilizing the active notes application of the invention. In this example, the user selects using CBA helpers the edit and insert functions and inserts the subject of the meeting, in this case “bridge meeting” generally designated 200 and then selects the “mark as To Do” from the CBA. Now in this instance it is desired to call individuals and under the To Do heading the user types in “call” and then selects “insert person” from the CBA. In this instance, the person John Doe 202 and Mike Smith 204 are selected and inserted. The To Do task also include preparing material and within this task it is required to edit certain documents. The user types “edit” and then selects “insert file” from the CBA and in this case the insert files are named agenda.doc 208 and UI.ppt 210. Turning now to FIG. 4, it is desired to add further tasks for example to an existing note such as that shown in FIG. 3.

The user would type “edit” and insert for example “check” and then selects a desired URL address www.nokia.com 212 from the web browser by selecting “insert” from the CBA. It might also be desired to add a further task such as “send” a document to a person by using the CBA helpers, for example send the document “UI.ppt to John Doe” 214.

In a further example of the active note application embodying the present invention, consider the note: “Send the Active Notes Specification document v0.1 by email to Kimmo Ramo”. In this note, three (3) different points are portrayed as indicated by the underlined words in addition to the meaning of the sentence itself: 1) a particular document that exists somewhere in the terminal device; 2) an email program that exists somewhere in the terminal device by which the document should be sent; and 3) a contact name that may exist somewhere in the local contacts application that exists somewhere in the terminal device which should be used for the retrieval of the email address of the identified recipient Kimmo Ramo. Each of the data entries entered into the terminal device, ie., Active Notes Specification document v0.1, email, Kimmo Ramo is embedded into its associated application 32 running on the terminal device and linked together to create the active note. The keywords here are “Send the” and “by email to” and the active elements being “Active Notes Specification document v0.1” and “Kimmo Ramo”. In this example, there are a couple of keywords inter-related to the documents and contacts. Once the user moves the cursor to this note element, the CBA Buttons (as shown in FIG. 5 for example) get a new command (e.g. OK, Done) which execute the actions such as sends by email the document mentioned to the contact referred in the note with a single button press. The location aspects is that the keywords can be localized to different languages as found necessary. Now when the user invokes any of the underlined words that are contained in the note for example from the associated application, the active note is retrieved and shown to the user.

Consider the following scenario for example where a user is working in a document handling application such as a word processing application running on a terminal device upon which the active notes application of the present invention is installed and invokes the term Active Notes Specification document v0.1. The active note “Send the Active Notes Specification document v0.1 by email to Kimmo Ramo” would be shown to the user. The user could then invoke the term “email” which in turn would activate the associated email application and display the email address for the intended recipient “Kimmo Ramo”. The email address could automatically be inserted into the address line of the composer and the document Active Notes Specification document v0.1 could automatically be attached to the message in readiness for sending to “Kimmo Ramo”. The user could also type in “Send the Active Notes Specification document v0.1 to Kimmo Ramo” and the User Interface recognizing the intention to send the document provides a button on the display to send the message via MMS for example. The active notes application may also prompt the user to make additional entries or take additional actions. For example, the user could be asked to enter Kimmo Ramo′ telephone number or other personal information for example work number, mobile number, location address, and other such information related to Kimmo Ramo. The active notes application of the invention might also invoke a media application and display a photo of Kimmo Ramo for the user to view. Now there also may be some calendar events scheduled for Kimmo Ramo and the user. The active notes application may prompt the user by invoking the calendar application and asking if the user wishes to view the calendar events scheduled with Kimmo Ramo. Now any events viewed would show the data in the active note for any actions that may be associated with the event. Thus it is seen that the active notes application of the present invention is interactive with notes being triggered and made available based on external events and actions, notes being retrieved from cataloged notes based on keywords or application identifiers, linking the active notes to other applications for updating and extracting and including data in the active notes and behavior responses to make relevant commands available as specific test is entered in addition to other interactions identified and illustrated herein.

In a further example, consider the note “Call Kimmo Ramo to discuss about Project Deadline 31 Dec. 2000”. In this note, three (3) different points are again portrayed in addition to the sentence itself: 1) an action namely the need to make a phone call, 2) call to be made to the intended recipient Kimmo Ramo, and 3) discuss about a particular task namely Project Deadline 31^{st} Dec. 2005. In this example, a button to make a call may be displayed for the user to invoke a calling application in which the active notes application causes a call list to be displayed and prompts the user to select the name of the intended recipient, in this case Kimmo Ramo. The associated application then displays the name Kimmo Ramo and shows the telephone number beside the name if the number has been previously entered and stored. If for example the number has not been stored and the user keys in the number to dial it, the active notes application may prompt the user to save the number in the appropriate application which may give rise to other related applications prompting the user to input related data in accordance with the requirements of the particular application's intended function, for example, address data. In addition the active note “Call Kimmo Ramo to discuss about Project Deadline 31 Dec. 2000” is displayed and shown to the user. Further, any additional active notes concerning Kimmo Ramo may be displayed and shown to the user. Further, any active notes related to the “Project Deadline 31 Dec. 2000” may be retrieved from the cataloged notes and shown to the user. The user may if desired invoke the associated application, for example a document handling application by selecting the term “Project Deadline 31 Dec. 2000” shown in the active note to display text, graphics, etc. contained in the underlying document the active notes application may prompt the user with other possible actions such as providing a print button, send button, edit button, etc. to carry out a desired action or function.

Now, if we consider the opposite situation in which the identified recipient in the above active note Kimmo Ramo makes a call to the user of the active notes rather than the user calling the intended recipient, the user would receive the call and upon identifying Kimmo Ramo via caller ID or other methods including user selection via highlighting, stylus contact on the screen display, etc. is reminded of the action recorded in the active note because the active note is now displayed to the user. In usual situations this note would be hidden somewhere in the file system in a static manner and not be made known to the user unless the user remembered something about the note content and manually retrieved the note. In the active note application of the present invention, the active note is automatically retrieved and shown to the user upon receiving the call from the intended recipient Kimmo Ramo. A similar situation arises when the identified recipient Kimmo Ramo visits the user in that nothing normally ever happens to these notes that are taken unless the user happens to remember something about the note content and manually retrieves the note. In the active note application of the present invention the active note is automatically retrieved and shown to the user when the user invokes the name of Kimmo Ramo.

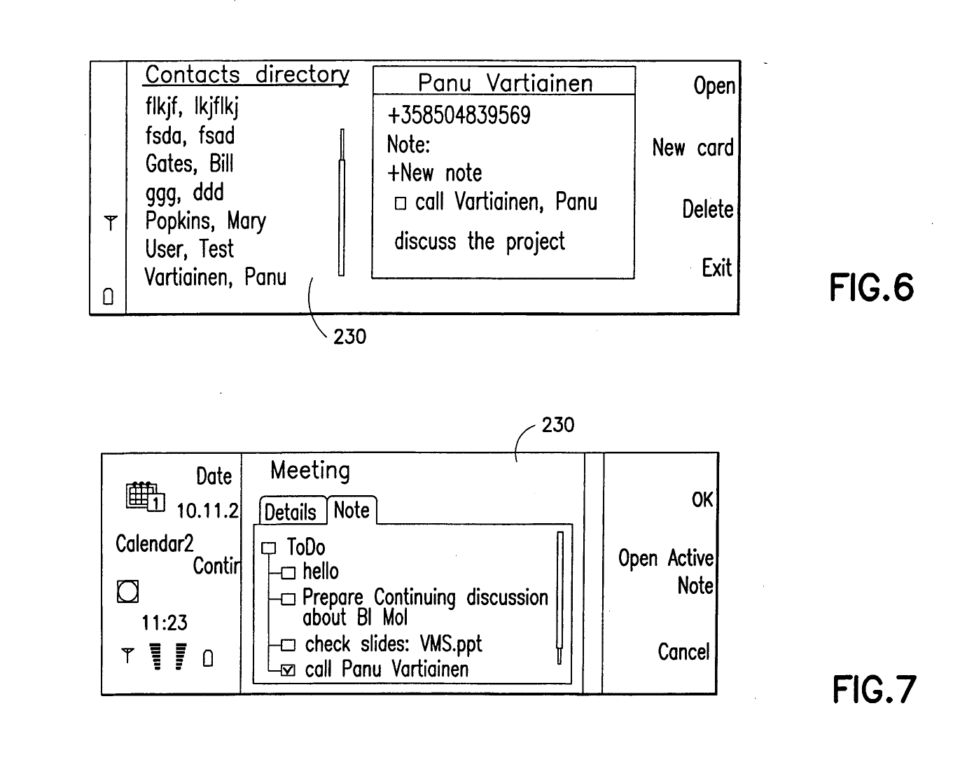

Turning now to FIGS. 5-7, a further explanation of the active notes application of the invention is described with respect to an application UI adapter 12 as referenced above. In this example, a call is received from “Panu Vartiainen” and if the recipient had a To Do or note related to the caller Panu, the tasks related to Panu would be seen on the display screen 230. Now further consider if there were any notes made related to Panu Vartiainen and further there is an entry in the phone contacts, the user is able to see all notes made about Panu Vartiainen when the contacts directory is opened as illustrated in the UI in FIG. 6.

In a further example of an application UI adapter in the active notes application embodying the present invention and with reference to FIG. 7, if a calendar event is present and there are some notes made related to the calendar event, the all the active note made related to the event from the calendar application can be seen on the screen 230 of the mobile device with which the active notes application is used.

The note taking in the present invention is itself simplified because words or options are proposed to the user when the user is keying in each of the words of the note. The information embedded in the note itself can then be easily accessible by directly invoking key word at a later time as described above.

The input device 16 may also be a shared active note. For example, consider the Active Notes has a list of things “to do” at a Manager's mobile device. In this example the following Active Notes “State Suresh Chande Task is <Assigned>”, “State Kimmo Ramo Task is <Started>”, and “State Panu Vartiainen Task is <UnAssigned>” are present. These notes are active and the “State” in this case the Assigned, Unassigned and Started are active and dynamically changing as the value of this entry comes from an external Active Note which is on the devices of Suresh Chande, Kimmo Ramo and Panu Vartiainen which communicate with the Manager's mobile device.

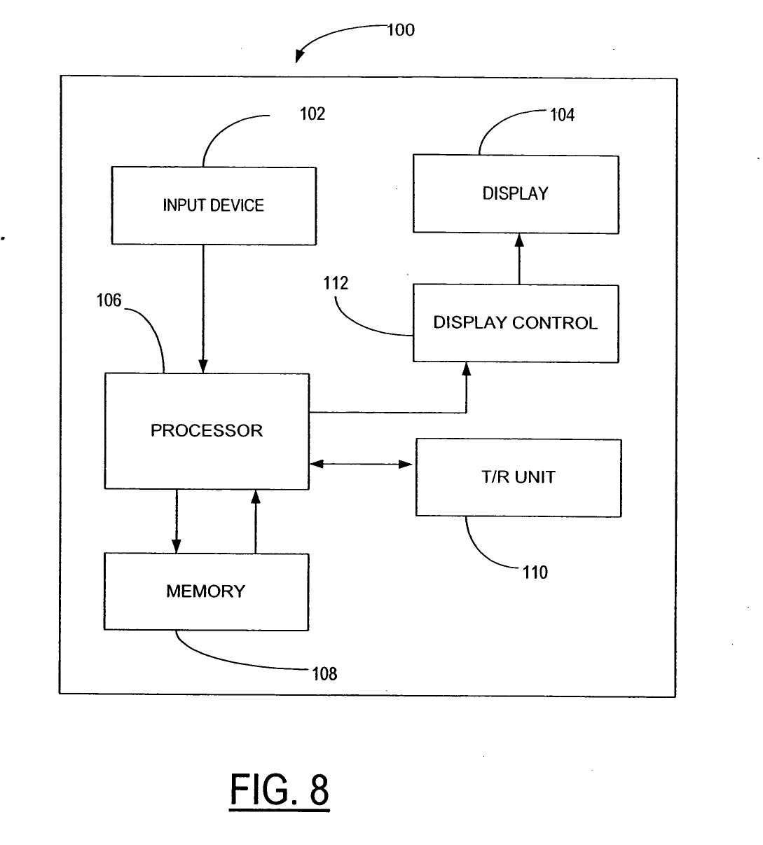

FIG. 8 illustrates the major functionality blocks of a suitably configured terminal device with which the active note application of the present invention may be utilized. The terminal device includes an input device such as a keypad 102 and a display such as a touch screen other suitable display 104. A processor 106 controls the operation of the terminal device in accordance with an instruction set contained in a memory 108 to direct the operation of the terminal device which may also include a transit/receive unit 110 in the case of a mobile device and a display control unit 112. The memory 108 also stores for retrieval the active note application embodying the present invention as shown in FIG. 1. The processor 106 executes a computer program, which is carried on a storage medium and may be loaded and stored in the memory 108 in a manner well known to those skilled in the art. Although a generic terminal device is described herein, any suitably configured device may be utilized to carry out the functions and operation of the active note application embodying the invention.

The invention claimed is:

1. Method, comprising the steps of:
invoking a notes application in response to a user action or automatic event;
entering data into the notes application;
entering an action event into the notes application;
embedding the entered data into an associated application;
executing the action with the data specified; whereby the notes are made active.

2. The method as defined in claim 1 wherein the step of executing the action with the data specified is carried out by an associated application for the type of action identified.

3. The method as defined in claim 1 further comprising the step of sharing the embedded entered data with one or more other associated applications.

4. The method as defined in claim 1 further comprising the step of automatically invoking an associated application in response to the content type of the entered data to prompt the user to add an associated action or event corresponding to the invoked associated application functionality.

5. The method as defined in claim 1 further comprising the step of cataloging the active notes for retrieval and viewing in response to invoking a keyword in the active note.

6. The method defined in claim 5 further comprising the step of mapping keywords to associated actions whereby invoking one or more keywords identify a given action for execution with the specified data.

7. The method as defined in claim 6 further comprising the step of providing the keyword in one or more languages whereby localization is accommodated.

8. The method as defined in claim 1 wherein the data is an identifying name.

9. The method as defined in claim 1 wherein the data is contact information.

10. The method as defined in claim 1 wherein the data is a date.

11. The method as defined in claim 2 wherein the associated application is a contact manager application.

12. The method as defined in claim 2 wherein the associated application is a document handling application.

13. The method as defined in claim 2 wherein the associated application is a calendar application.

14. The method as defined in claim 2 wherein the associated application is a phone book application.

15. The method as defined in claim 2 wherein the associated application is an address book application.

16. The method as defined in claim 2 wherein the associated application is a word processing application.

17. The method as defined in claim 2 wherein the associated application is a spreadsheet application.

18. The method as defined in claim 2 wherein the associated application is a contacts application.

19. The method as defined in claim 2 wherein the associated application is a browser application.

20. The method as defined in claim 2 wherein the associated application is a messaging application.

21. The method as defined in claim 1 wherein data is entered using a suitably configured input-device.

22. The method as defined in claim 21 wherein the input device is a keyboard.

23. The method as defined in claim 21 wherein the input device is a voice recognition device.

24. The method as defined in claim 21 wherein the input device is a touch screen.

25. The method as defined in claim 21 wherein the input device further comprises a shared active note.

26. The method as defined in claim 1 wherein the active note is created in response to an external action or event.

27. The method as defined in claim 1 wherein the notes application runs on a suitably configured terminal device.

28. The method as defined in claim 27 wherein an active note is available during an ongoing mobile connection.

29. Computer program carried on a storage medium and executable by a processor in a suitably configured device running a notes application and at least one associated application and arranged for entering an action event and embedding the data to the associated application wherein the associated application executes the identified action event with the data specified to make the notes active.

30. A mobile device suitably configured for running a notes application and at least one associated application including means for entering an action event and embedding the entered data into the associated application and executing the action with the data specified whereby the notes are made active.
